(19) United States
(12) Patent Application Publication
(10) Pub. No.: US 2024/0095579 A1
(43) Pub. Date: Mar. 21, 2024

(54) RESTRICTED REUSE OF MACHINE LEARNING MODEL DATA FEATURES

(71) Applicant: AT&T Intellectual Property I, L.P., Atlanta, GA (US)

(72) Inventors: Prince Paulraj, Coppell, TX (US); Antoine Diffloth, Frisco, TX (US); James Pratt, Round Rock, TX (US)

(21) Appl. No.: 17/949,787

(22) Filed: Sep. 21, 2022

(51) Int. Cl. G06N 20/00

(52) U.S. Cl. CPC G06N 20/00

(57) ABSTRACT

A processing system including at least one processor may obtain a request from a first entity to train a machine learning model, access at least one data feature of at least a second entity, and train the machine learning model on behalf of the first entity in accordance with the at least one data feature of the at least the second entity to generate a trained machine learning model, where the at least one data feature of the at least the second entity is a restricted data feature that is inaccessible to the first entity. The processing system may then provide the trained machine learning model to the first entity.

The present disclosure relates generally to machine learning, and relates more particularly to methods, non-transitory computer-readable media, and apparatuses for training a machine learning model on behalf of a first entity in accordance with at least one restricted data feature of at least a second entity that is inaccessible to the first entity to generate a trained machine learning model.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for training a machine learning model on behalf of a first entity in accordance with at least one restricted data feature of at least a second entity that is inaccessible to the first entity to generate a trained machine learning model may operate;

FIG. 2 illustrates an example system including a data sharing platform, according to the present disclosure;

FIG. 3 illustrates a flowchart of an example method for training a machine learning model on behalf of a first entity in accordance with at least one restricted data feature of at least a second entity that is inaccessible to the first entity to generate a trained machine learning model; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for training a machine learning model on behalf of a first entity in accordance with at least one restricted data feature of at least a second entity that is inaccessible to the first entity to generate a trained machine learning model. For instance, in one example, a processing system including at least one processor may obtain a request from a first entity to train a machine learning model, access at least one data feature of at least a second entity, and train the machine learning model on behalf of the first entity in accordance with the at least one data feature of the at least the second entity to generate a trained machine learning model, where the at least one data feature of the at least the second entity is a restricted data feature that is inaccessible to the first entity. The processing system may then provide the trained machine learning model to the first entity.

Machine learning is a subset of artificial intelligence encompassing computer algorithms whose outputs improve with experience. A set of sample or “training” data may be provided to a machine learning algorithm, which may learn patterns in the training data that can be used to build a model that is capable of making predictions or decisions (outputs) based on a set of inputs (e.g., new data). Machine learning models may be used to automate the performance of repeated tasks, to filter emails, to provide navigation for unmanned vehicles, and to perform numerous other tasks or actions. Recent developments allow even individuals with minimal data analysis expertise to build, train, and deploy machine learning models. For instance, the ability to reuse existing machine learning models (or even parts of existing machine learning models) to build new and potentially different machine learning models allows developers to leverage techniques that are already known to work, rather than build new machine learning models completely from scratch. As such, repositories of reusable machine learning models and features (also referred to as “feature stores”) are becoming more commonplace. As referred to herein, data features may include machine learning features and feature sets, transformed data, streaming data transformations, or the like.

In one example, the present disclosure provides for the development of a machine learning model (MLM) using data features obtained from different entities (e.g., from different feature stores). For instance, a first feature store may have hundreds of data feature sets and thousands of data features. Similarly, a second feature store may have hundreds of other data feature sets and thousands of other data features. In one example, an entity may seek to generate an MLM using data features across both data feature stores in pursuit of improved performance, different insights, and so forth. In one example, the requesting entity (and others) may then access an MLM thus trained from disparate features (e.g., coming from different eco-systems) in order to federate learning. Notably, the assemblage of data features for MLM training may be done in a secure way, where a modeling system manages communication with each data feature store, coordinating encryption from each data feature store, e.g., to enable joining and bridging tables across eco-systems via the modeling system for purposes of training the MLM.

Notably, in accordance with the present disclosure, the data feature(s) from at least one of the feature stores may comprise “restricted” data feature(s). For instance, restricted data features may comprise data features that are in a catalog and are made available for use in MLM training, but only via the modeling system from the perspective of non-owner entities. In addition, “restricted” may mean that the data contents of a data feature are not available to the requesting entity to view, query, sample, or otherwise access or explore via the modeling system or via a computing device and/or processing system of the requesting entity seeking to use the data feature for MLM training. For instance, other entities (e.g., non-owners) that want to use the data feature(s) for MLM training cannot access/view/explore the contents of the data feature(s). They may be provided only with metadata about the data feature(s), e.g., schema, data range, mean, median, entropy, etc., identity of data feature owner, or the like. In addition, the requesting entity is not provided with the data feature(s) even in encrypted form. Only the modeling system that is independent from the requesting entity may access and use the data feature(s) to train the model on behalf of the requesting entity. It should be noted that the entity requesting training of an MLM can upload their own data features for training, e.g., as non-restricted data features. However, data features of other entities that are restricted shall remain restricted (not accessible) to the requesting entity.

In one example, the utilization of data features to train an MLM may be recorded in the feature catalog and/or provided as feedback/additional metadata of the data features. For instance, the feedback may include information noting that a data feature was used to train an MLM, may include an identification of the requesting entity, may include information regarding the nature of the MLM (e.g., the subject matter of the MLM, such as for “transportation,” “home automation,” “education,” etc.), may include other information regarding the MLM (e.g., the type of the MLM, the hyperparameters, other data features used for training the MLM, etc.), and so forth.

It should again be noted that examples of the present disclosure facilitate MLM training across data features owned by different entities which may be otherwise hesitant or unwilling to share their data features with each other. In addition, while data features may be owned and maintained by different entities, in some cases, users (e.g., customers, subscribers, etc.) may have privacy, security, contractual, and/or other rights to contents of certain data features. Thus, in some instances, it is insufficient that a data owner entity is willing to share a data feature. Rather, the obtaining of user consent may also be involved. Nevertheless, individuals may be more willing to permit the limited usage of restricted data features in accordance with the present disclosure, wherein the architecture is specifically designed to prevent entities from actual access to each other's data features, other than for the limited purpose of MLM training, and only then via an MLM development system that is independent from the entity requesting MLM training.

To illustrate, in one example, a user may have network-connected home automation devices from different ecosystems (e.g., one or more home automation devices of a first vendor (e.g., a first ecosystem) and one or more home automation devices of a second vendor (e.g., a second ecosystem)). In addition, the user may prefer that each vendor does not have unrestricted access to data collected from home automation devices within the other's ecosystem. In other words, the user does not want vendor 1 to have user data collected form vendor 2's devices, and vice versa. However, the user may wish to permit generalized MLMs to be trained based on data from both ecosystems (e.g., when are the best times of the day to use hot water across different appliances, when should thermostats be adjusted in different zones and to what temperature(s) (e.g., where different zones may have devices of one or both ecosystems), when should lights be turned on and off in different zones, what light output settings should be selected, and so forth). In accordance with the present disclosure, an MLM development system may access data from both ecosystems to train a model, while neither vendor is able to access the other's restricted data features. Thus, automated machine learning can occur while still maintaining each ecosystem's restricted (e.g., proprietary or otherwise limited-access) data features with the user's specific consent. Notably, the trained MLM may be shared by both vendor's ecosystems within the user's premises.

Similarly, in another example, the present disclosure may provide for MLM training with remote education and cross-institutional data feature aggregation. For instance, a trained MLM may provide insights for multiple school districts based on restricted data from each. As in the previous example, a first district may maintain student data as one or more restricted data features and may not share such data with other districts (or other entities that may desire to use such data). However, such restricted data feature(s) may be made available for use in training an MLM without being accessed by other districts or other entities. Similarly, a second district may enable one or more restricted data features to be made available for limited use in MLM training by an MLM development system (where the data feature(s) remain(s) inaccessible to other entities). In one example, different districts may also have different ecosystems (e.g., different emails systems from different vendors, different records management applications, etc.). Again, consent must be obtained from the owners of the restricted data features for training the MLM.

It should be noted that in some examples, the trained MLM may be provided to a requesting entity for deployment. For instance, a first entity may deploy the MLM for prediction, forecasting, or the like based on new input data. Notably, the input data may include data relating to the restricted data feature(s) of other entities. In one example, the entity deploying the trained MLM may be permitted to access individual instances of data relating to the restricted data feature(s) for purposes of run-time operation. For instance, the trained MLM may be permitted to access a user's current location information, but does not have access the user's location history over the past six months (which may represent the contents of a restricted data feature that was used to train the MLM). However, in another example, an MLM development system may retain the trained MLM for deployment. When an entity desires to obtain a run-time output of the trained MLM, it may request that input data be applied to the trained MLM. The MLM development system may thus apply the input data to the trained MLM, obtain an output, and provide the output the requesting entity. In other words, in this example, the requesting entity is also restricted from obtaining the run-time input data associated with the restricted data feature(s) by deploying and running the model independent from the requesting entity.

In another example, the present disclosure may relate to forecasting based on an aggregation of weather data with telecommunication network data (e.g., user device locations, network traffic volume, etc.), road closure data and/or equipment data, or the like, e.g., for disaster situational awareness and action. Still another example may relate to transportation services (e.g., pickup or delivery of passengers or other items). In addition, this may facilitate sellers having an opportunity to sell items of interest in an “instant gratification” model. Likewise, customers can receive delivery of purchased items on an expedited basis. For example, sellers may partner with various delivery channels based on location. In one example, sellers and transportation service providers may provide restricted data features to train an MLM for predicting deliveries to help better plan efficient vehicle routes. In another example, a trained MLM based on aggregated restricted data features from multiple entities may also be used to make more efficient deliveries to third parties who also share their current and predicted future location information. For instance, a seller may arrange with a transportation service provider for a delivery at a predicted future location of a proxy for the buyer. Thus, variations of the above may be used to schedule a future pickup (e.g., matching a future location of a vehicle of a transportation service provider with a future location of a person for giving a package (e.g., for delivery by the transportation service provider, for transporting the person as a passenger, for delivering one or more items to the person, etc.)).

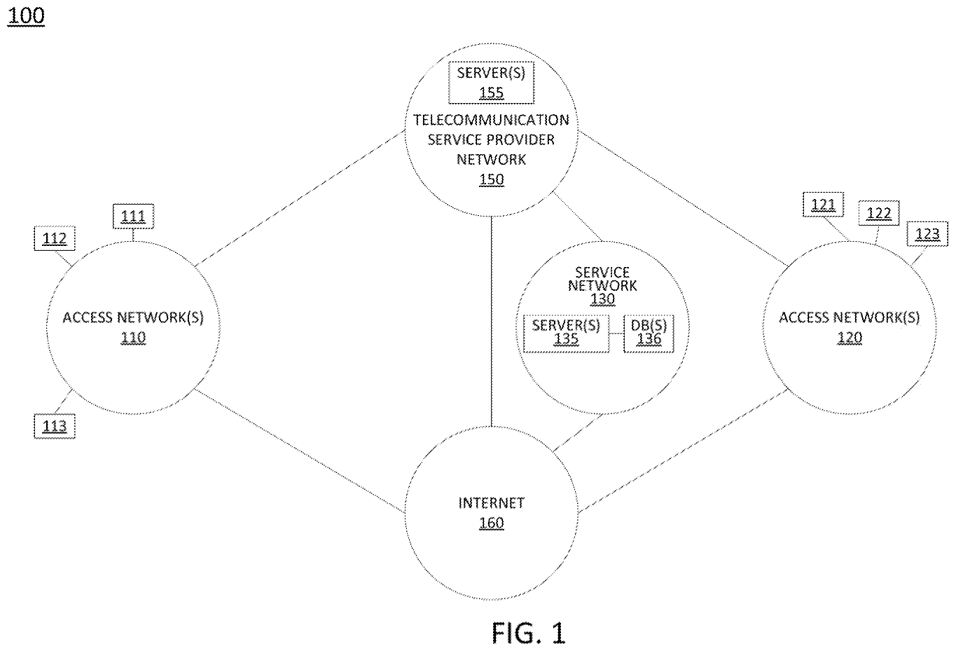

It should be noted that in all of these examples, encryption may be applied to restricted data features at rest (e.g., when stored in a data storage system) and in motion (e.g., when transmitted between data storage systems) to assure confidentiality of user data or other confidential data. At the same time, examples of the present disclosure provide interoperability between different learning ecosystems, enabling common keys across feature stores to combine data features, e.g., data of one or more users to be used for model generation/training. In one example, the present disclosure may provide governance mechanisms for the reuse of restricted data features (and/or other data features (e.g., non-restricted data features)) as well as the machine learning models that may be generated therefrom. In one example, restricted data features may be automatically identified when added to a catalog of data features, such as by identifying quantifiable similarity between a new data feature and one or more existing data features that are already designated as restricted data features. In one example, the present disclosure may also provide for data anonymization, such as via masking data values that are not necessary for model training, generalizing data values (e.g., within a range of the actual value(s)), using homomorphic encryption, or the like). Thus, data that is identified as sensitive may be protected in an automated manner when reused in future machine learning models. In further examples, the data lineage of machine learning models and features that are provided for reuse may be traced, so that information on data origins can be provided for consideration. These and other aspects of the present disclosure are discussed in greater detail below in connection with the examples of FIGS. 1-4.

To aid in understanding the present disclosure, FIG. 1 illustrates an example system 100 comprising a plurality of different networks in which examples of the present disclosure for generating a notification indicating at least one anomaly in a time series data set may operate. Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed-mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office.

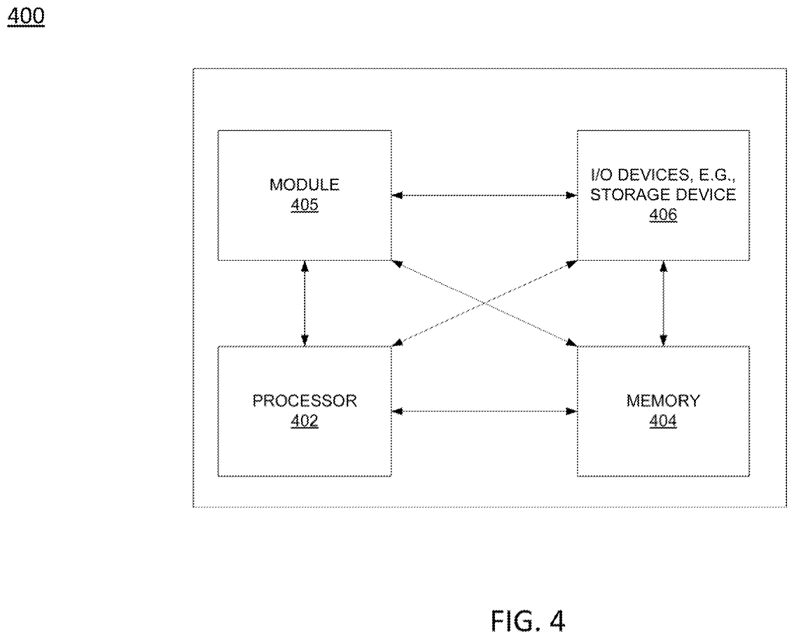

In one example, telecommunication service provider network 150 may also include one or more servers 155. In one example, the servers 155 may each comprise a computing system, such as computing system 400 depicted in FIG. 4, and may be configured to host one or more centralized system components in accordance with the present disclosure. For example, a first centralized system component may comprise a database of assigned telephone numbers, a second centralized system component may comprise a database of basic customer account information for all or a portion of the customers/subscribers of the telecommunication service provider network 150, a third centralized system component may comprise a cellular network service home location register (HLR), e.g., with current serving base station information of various subscribers, and so forth. Other centralized system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other centralized system components may include, for example, a layer 3 router, a short message service (SMS) server, a voicemail server, a video-on-demand server, a server for network traffic analysis, and so forth. It should be noted that in one example, a centralized system component may be hosted on a single server, while in another example, a centralized system component may be hosted on multiple servers, e.g., in a distributed manner. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, endpoint devices 121-123, and service network 130, and between telecommunication service provider network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. For example, one or both of the access networks 110 and 120 may comprise an ISP network, such that endpoint devices 111-113 and/or 121-123 may communicate over the Internet 160, without involvement of the telecommunication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of endpoint devices 111-113 and 121-123 may represent one or more user devices and/or one or more servers of one or more data set/data feature owners, such as a weather data service, a traffic management service (such as a state or local transportation authority, a toll collection service, etc.), a payment processing service (e.g., a credit card company, a retailer, etc.), a police, fire, or emergency medical service, and so on. In one example, any one or more of endpoint devices 111-113 and 121-123 may represent one or more user devices and/or one or more servers of one or more entities that may seek to create and train one or more machine learning models (MLMs) using data features made available by data set/data feature owners via an MLM development platform. In one example, any one or more of such entities may also be a data set/data feature owner.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the telecommunication service provider network 150. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may provide service network 130 functions, e.g., of a public land mobile network (PLMN)-universal mobile telecommunications system (UMTS)/General Packet Radio Service (GPRS) core network, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the telecommunication service provider network 150. For example, the service network 130 may comprise one or more devices for providing services to subscribers, customers, and/or users. For example, telecommunication service provider network 150 may provide a cloud storage service, web server hosting, and other services. As such, service network 130 may represent aspects of telecommunication service provider network 150 where infrastructure for supporting such services may be deployed. In another example, service network 130 may represent a third-party network, e.g., a network of an entity that provides a data feature store and/or machine learning model development platform as a service to various other entities.

In the example of FIG. 1, service network 130 may include one or more servers 135 which may each comprise all or a portion of a computing device or system, such as computing system 400, and/or processing system 402 as described in connection with FIG. 4 below, specifically configured to perform various steps, functions, and/or operations for training a machine learning model on behalf of a first entity in accordance with at least one restricted data feature of at least a second entity that is inaccessible to the first entity to generate a trained machine learning model, as described herein. For example, one of the server(s) 135, or a plurality of servers 135 collectively, may perform operations in connection with the example method 300, or as otherwise described herein. In one example, the one or more of the servers 135 may comprise a data feature store and/or machine learning model development platform (e.g., a network-based and/or cloud-based service hosted on the hardware of servers 135).

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of systems for training a machine learning model on behalf of a first entity in accordance with at least one restricted data feature of at least a second entity that is inaccessible to the first entity to generate a trained machine learning model, as described herein. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFSTM), or the like.

In one example, DB(s) 136 may be configured to receive and store network operational data collected from the telecommunication service provider network 150, such as call logs, mobile device location data, control plane signaling and/or session management messages, data traffic volume records, call detail records (CDRs), error reports, network impairment records, performance logs, alarm data, and other information and statistics, which may then be compiled and processed, e.g., normalized, transformed, tagged, etc., and forwarded to DB(s) 136 directly or via one or more of the servers 135. The network operational data stored in DB(s) 136 may include: database throughput of one or more database instances (such as one or more of servers 155 of telecommunication service provider network 150), peak or average central processing unit (CPU) usage, memory usage, line card usage, or the like per unit time, peak or average device temperature, etc. with respect to network-based devices (e.g., one or more of servers 155), radio access network (RAN) metrics, such as peak or average number of radio access bearers, average or peak upload or download data volumes per bearer and/or per connected user equipment (UE)/endpoint device, etc., such as from one or more of access networks 110 or 120, metrics that may be used for intrusion detection/alerting, such as peak or average number of connection requests to a server, link utilization metrics (e.g., peak or average bandwidth utilization in terms of total volume or percentage of maximum link capacity), etc.

In one example, DB(s) 136 may receive and store biometric data of one or more users. For instance, one or more of endpoint devices 111-113 or 121-123 may represent a wearable biometric device that measures and may upload pulse data, ECG/EKG data, blood oxygen level data, movement data or positional data from which movement may be measured (e.g., quantified as a time series, such as number of steps per minute, pedals per minute, linear distance traveled per minute, or the like). Alternatively, or in addition, one or more of endpoint devices 111-113 or 121-123 may represent a mobile computing device that is connected to a wearable biometric device, e.g., via IEEE 802.15 based communications (e.g., “Bluetooth®,” “ZigBee®,” etc.) or via other wireless peer-to-peer communications, via wired connection, etc., where the endpoint device(s) collect and transmit the biometric data from the one or more connected biometric devices. Similarly, DB(s) 136 may receive and store weather data from a device of a third-party, e.g., a weather service, a traffic management service, etc. via one of the access networks 110 or 120. For instance, one of the endpoint devices 111-113 or 121-123 may represent a weather data server (WDS). In one example, the weather data may be received via a weather service data feed, e.g., an NWS extensible markup language (XML) data feed, or the like. In another example, the weather data may be obtained by retrieving the weather data from the WDS. In one example, DB(s) 136 may receive and store weather data from multiple third-parties. Similarly, one of the endpoint devices 111-113 or 121-123 may represent a server of a traffic management service and may forward various traffic related data to DB(s) 136, such as toll payment data, records of traffic volume estimates, traffic signal timing information, and so forth.

It should be noted that in each case, the data stored by DB(s) 136 relevant to the present disclosure may specifically be stored as “data features.” In one example, DB(s) 136 may store various data features as part of a data feature store, which can be used for various purposes, such as for training machine learning models, for applying as inputs to machine learning models for generating predictions, inferences, or the like, and so forth. In addition, the data features may be stored as part of various data sets. In one example, a data set may comprise one or more data tables having one or more columns and one or more rows (e.g., where the column(s) and row(s) may be referred to as data elements). As referred to herein, a “feature,” or “data feature,” may comprise a column of a data table. However, in some cases, a “data feature” may comprise a vector of values (which may be considered as a single-column table). Each data feature, whether part of a table or a standalone feature, may have a data feature label, or data feature name (e.g., a column title/header). In addition, each data feature may have data feature/column metadata. The metadata may include an identity of a data feature owner, restrictions (and/or permissions of a feature), lineage information (e.g., a source device or processing system of the contents of the data feature (e.g., retail store A, cell site Z, data center M, a 3^{rd} party, etc.), other data features from which a given data feature is derived, any machine learning model(s) of which a data feature may be an output, or the like (e.g., “feature z derived from features x and y,” “feature z derived from MLM A,” “feature z output of MLM A derived from features x and y,” etc.), fingerprint information (e.g., statistical data regarding a data feature, such as mean value, median value, high value, low value, an entropy metric, a uniqueness factor, etc.)), an identification of any machine learning models that may have used/are using the data feature as an input/predictor, and so forth. The data feature/column metadata may be stored in association with each data feature/column (e.g., on a per data feature/column basis) or may be stored as part of data set and/or data table metadata. In one example, a “feature store” may comprise all of the available data features (and data sets). In one example, metadata of the data feature store may comprise a “data dictionary.” In one example, all or some of the above aspects may be included as information for data features that are made available for searching via a data feature catalog.

In one example, DB(s) 136 may comprise multiple feature stores, e.g., one per entity participating in limited sharing of restricted data features in accordance with the present disclosure. Alternatively, or in addition, as mentioned above, any one or more of endpoint devices 111-113 and/or endpoint devices 121-123 may represent servers of one or more data set/data feature owners offering data sets for sharing, purchase, lease, download, licensing, etc. via server(s) 135. In other words, any one or more of endpoint devices 111-113 and/or endpoint devices 121-123 may represent a separate feature store of a participating entity. Alternatively, or in addition, any one or more of the user devices 111-113 and/or user devices 121-123 may comprise a client device for submitting proposed machine learning models to server(s) 135, for selecting restricted data features for training such machine learning models, and so forth. In this regard, server(s) 135 and/or DB(s) 136 may maintain communications with one or more of the endpoint devices 111-113 and/or endpoint devices 121-123 via access networks 110 and 120, telecommunication service provider network 150, Internet 160, and so forth, e.g., in order to obtain a request from a first entity to train a machine learning model, access at least one data feature of at least a second entity, train the machine learning model on behalf of the first entity in accordance with the at least one data feature of the at least the second entity to generate a trained machine learning model (e.g., where the at least one data feature of the at least the second entity is a restricted data feature that is inaccessible to the first entity, provide the trained machine learning model to the first entity, and so on).

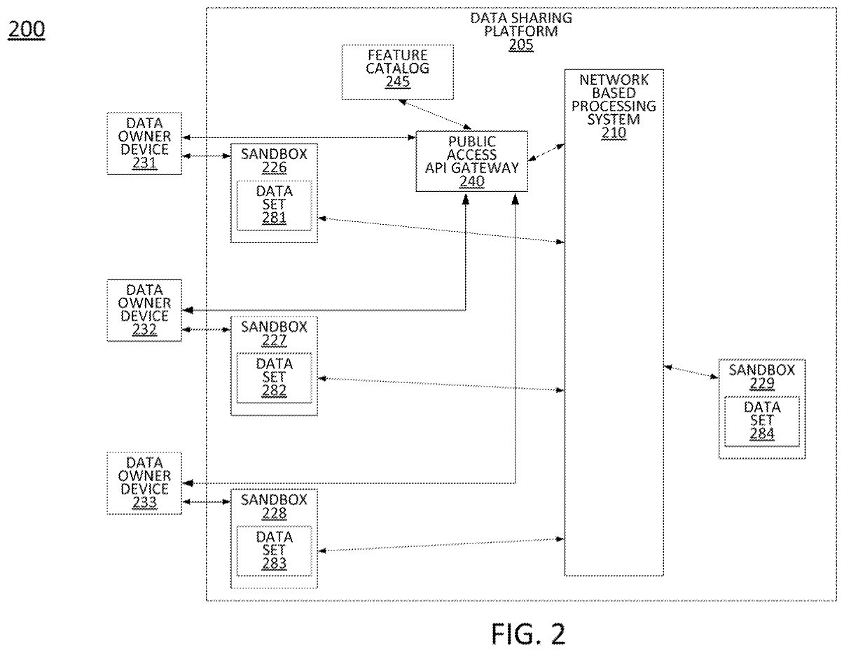

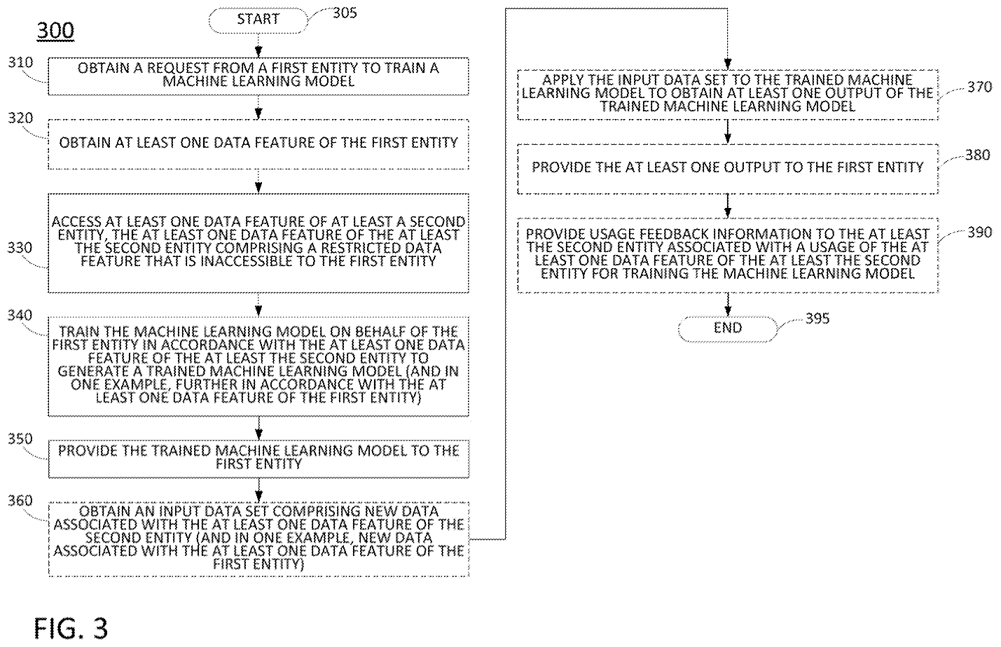

As noted above, server(s) 135 may be configured to perform various steps, functions, and/or operations for training a machine learning model on behalf of a first entity in accordance with at least one restricted data feature of at least a second entity that is inaccessible to the first entity to generate a trained machine learning model, as described herein. For instance, an example method for training a machine learning model on behalf of a first entity in accordance with at least one restricted data feature of at least a second entity that is inaccessible to the first entity to generate a trained machine learning model is illustrated in FIG. 3 and described in greater detail below. In addition, server(s) 135 may perform various additional operations as described in connection with FIG. 2, or elsewhere herein. These operations may be with respect to telecommunication network operational data and/or user data, biometric/medical data, network connected appliance/smart building data, transportation service data, weather data, and so forth, such as stored in DB(s) 136 or as otherwise obtained from any one or more components of the system 100.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in telecommunication service provider network 150, and so forth. Thus, these and other modifications are all contemplated within the scope of the present disclosure.

FIG. 2 illustrates an example system 200 including a data sharing platform 205 (e.g., a network-based data sharing platform). In one example, the data sharing platform 205 may comprise a processing system, e.g., a server or multiple servers collectively configured to perform various steps, functions, and/or operations in accordance with the present disclosure. In one example, the data sharing platform 205 includes a network-based processing system 210, e.g., a server or multiple servers collectively configured to perform various steps, functions, and/or operations in accordance with the present disclosure. In one example, data sharing platform 205 may be represented by server(s) 135 and/or DB(s) 136 in FIG. 1, or vice versa. In one example, the network-based processing system may comprise all or a portion of a computing device or system, such as computing system 400, and/or processing system 402 as described in connection with FIG. 4 below, specifically configured to perform various steps, functions, and/or operations in accordance with the present disclosure. It should also be noted that the components of network-based processing system 210 and the data sharing platform 205 may comprise various combinations of computing resources (e.g., processor(s), memory unit(s), and/or storage unit(s)) on the same or different host devices, at the same or different locations (e.g., in the same or different data centers). For example, processors assigned to execute instruction sets for different components may be separate from the associated memory resources, which may be separate from associated storage resources where data sets or other data are stored, and so on.

As further illustrated in FIG. 2, the data sharing platform includes a plurality of sandboxes 226-229 (e.g., “private sandboxes’) and a public access application programming interface (API) gateway 240. In various examples, sandboxes 226-229, the data sets 281-284 stored in the different sandboxes 226-229, and/or the public access API gateway 240 may comprise virtual machines, application containers, or the like operating on one or more host devices. In addition, each of sandboxes 226-229, the data sets 281-284 stored in the different sandboxes 226-229, and/or the public access API gateway 240 may comprise various combinations of computing resources, e.g., processor(s), memory unit(s), and/or storage unit(s) on one or more shared host devices and/or on separate host devices. Each of the data sets 281-284 may take a variety of different forms. However, for illustrative purposes, data sets 281-284 may be considered to each include at least one table (e.g., containing at least one row and at least one column). In any case, each of the data sets 281-284 may include at least one data feature. In addition, at least some of the data features may comprise restricted data features, e.g., available for limited use by other entities via the data sharing platform 205, as described herein. In addition, for illustrative purposes, the data sharing platform 205 may comprise a relational database system (RDBS). However, in other, further, and different examples, data sharing platform 205 may comprise a different type of database system, such as a hierarchical database system, a graph-based database system, etc.

In one example, each of sandboxes 226-228 may comprise a feature store. In one example, any one or more of sandboxes 226-228 may be separately hosted and maintained by the respective data owners. In another example, any one or more of sandboxes 226-228 may hosted on shared infrastructure within the network-based processing system 210 (e.g., where a trusted entity controls and operates the data sharing platform, but where the data owners have independent control and access of the respective sandboxes 226-228 and the data sets 281-283 stored therein). For instance, a provider of a machine learning model development service via the data sharing platform 205 may also securely and separately store data sets 281-283 in sandboxes 226-228 on behalf of the respective data owners (e.g., as separate components of a feature store, or as multiple feature stores having features that are collectively accessible via the data sharing platform 205).

The data sharing platform 205 may provide services to a number of different users, and interact with a number of user devices, such as data owner devices 231-233. Each of the user devices may comprise a desktop computer, a cellular smart phone, a laptop, a tablet computer, a cloud based processing system providing a user environment, and so forth. In particular, data sharing platform 205 may be operated by a trusted party to store data sets on behalf of data owners in a secure and restricted manner, to provide for the use of restricted data features, e.g., for training of machine learning models via the data sharing platform 205 in accordance with authorizations from data owners, and so on. To illustrate, sandbox 226 may store data set 281 for a first data owner, which may comprise network operational data collected from a telecommunication service provider network, such as call logs, mobile device location data, control plane signaling and/or session management messages, data traffic volume records, call detail records (CDRs), error reports, network impairment records, performance logs, alarm data, and other information and statistics. The data set 281 may include raw data and/or may include data that have been normalized, transformed, tagged, etc. before uploading to the data sharing platform 205. In one example, the data in data set 281 may be uploaded via data owner device 231 and stored in sandbox 226. Alternatively, or in addition, the data sharing platform 205 may be configured to obtain and/or receive the data comprising data set 281 directly from a telecommunication network infrastructure (not shown). The sandbox 226 may represent a secure data storage and data processing environment that is only accessible to the first data owner (or another person or entity authorized on behalf of the first data owner) and to the network-based processing system 210.

Similarly, sandbox 227 may store data set 282 for a second data owner, which may comprise weather data of a weather service provider. The data set 282 may include raw data and/or may include data that have been normalized, transformed, tagged, etc. before uploading to the data sharing platform 205. In one example, the data in data set 282 may be uploaded via data owner device 232 and stored in sandbox 227. Alternatively, or in addition, the data sharing platform 205 may be configured to obtain and/or receive the data comprising data set 282 directly from a server of the weather service (not shown). For instance, the weather data may be received via a weather service data feed, e.g., a National Weather Service (NWS) extensible markup language (XML) data feed, or the like. The sandbox 227 may represent a secure data storage and data processing environment that is only accessible to the second data owner (or another person or entity authorized on behalf of the second data owner) and to the network-based processing system 210.

In addition, sandbox 228 may store data set 283 for a third data owner, which may comprise toll payment data, records of traffic volume estimates, traffic signal timing information, and so forth of a traffic management service. The data set 283 may include raw data and/or may include data that have been normalized, transformed, tagged, etc. before uploading to the data sharing platform 205. In one example, the data in data set 283 may be uploaded via data owner device 233 and stored in sandbox 228. Alternatively, or in addition, the data sharing platform 205 may be configured to obtain and/or receive the data comprising data set 283 directly from a server of a traffic management system (not shown). The sandbox 228 may represent a secure data storage and data processing environment that is only accessible to the third data owner (or another person or entity authorized on behalf of the third data owner) and to the network-based processing system 210.

In one example, the various data owners may make portions of the data sets 281-283 available to other users of the data sharing platform 205 (e.g., other entities) as “restricted features,” e.g., features that are not accessible to the other entities for viewing, data exploration, etc., but which may be used for machine learning model training via the network-based processing system 210 of the data sharing platform 205. In one example, each of the sandboxes 226-228 may comprise a separate feature store that is dedicated to a respective data owner associated with one of the data owner devices 231-233. In another example, data sharing platform 205 may comprise a feature store in which data owners contribute respective data sets that are securely stored in a segregated manner, e.g., in separate sandboxes 226-228 with different encryption keys, different access codes/password protection, etc.

In one example, the data sharing platform 205 may provide access to a data feature catalog 245, e.g., via public access API gateway 240. The data feature catalog 245 may include information about data features available from the various data sets 281-283 in the various sandboxes 226-228. For instance, the information may include data feature metadata including, for each data feature: a data feature label/name, ownership information, an ontology, a text description (e.g., provided by a data owner), lineage information, a data profile (e.g., statistical information of the data feature, including a date/time range, mean, median, high value, low value, entropy, etc.), a data type, format, and/or schema, machine learning models that have been trained using the data feature, ratings or comments of other users of the data feature, recommendations of similar data features, complementary data features, and so forth. In an example in which data sharing platform 205 supports restricted and non-restricted data features, the data feature catalog 245 may also identify for each data feature whether the data feature is restricted or not. In one example, a data feature may also be provided with different access/permission levels. For instance, a data set owner may designate one or more external entities for having unrestricted access to a data feature, while the data feature may remain “restricted” for any other entities.

Thus, for example, a requesting entity, e.g., via one of the data owner devices 231-233, may access the data feature catalog 245 and may identify the availability of the data feature(s) deemed of interest to the training of a machine learning model. For illustrative purposes, the requesting entity may be associated with data owner device 231. In one example, once the requesting entity identifies the data feature(s) of interest from the data sets 281-283, the requesting entity may then request training of a machine learning model in accordance with the data feature(s) from the respective data sets 281-283. For illustrative purposes, it may be assumed that at least some of the desired feature(s) comprise restricted data features of one or more other data owners to which the requesting entity is not entitled to access. As such, in accordance with the present disclosure, the machine learning model may be uploaded to the network-based processing system 210 via the public access API gateway 240 for training via the data sharing platform 205 on behalf of the requesting entity.

In one example, a sandbox 229 may be instantiated for this task and the uploaded machine learning model may be placed therein. Alternatively, the data sharing platform 205 may comprise a complete machine learning model development platform. Thus, the machine learning model may be created from a template (e.g., a machine learning algorithm with various pre-set or user-selected hyperparameters) that is available via an MLM catalog/repository of the data sharing platform 205. In one example, partial development of the machine learning model may be provided via sandbox 226, such as hyperparameter selection, training of the MLM via the data owner's own data features, etc.

In one example, the network-based processing system 210 may access any data features of other data owners that is/are to be used to train the MLM, e.g., from data set 282 and/or data set 283, and may populate such features into data set 284 of sandbox 229. In one example, data set 284 may comprise only those features that will be used for the specific MLM training. In one example, the network-based processing system 210 may be permitted to access restricted data features as a trusted intermediary/third party, wherein no human (unless separately permitted by the data owner(s)) is enabled to access the respective restricted data feature(s). For instance, only the network-based processing system 210 and the respective data feature owner may have an encryption/decryption key to the respective sandbox, the respective data set, and/or the respective data feature.

It should be noted that in one example, the request may specify that the machine learning model is to be trained using at least one data feature of the requesting entity (e.g., from data set 281). As such, one or more of these data features may be retrieved from data set 281 and populated into data set 284. Alternatively, or in addition, the requesting entity may upload one or more new data features for training the MLM, e.g., via data owner device 231, which may also be populated into data set 284 (and in one example, into data set 281, e.g., for future use by the data owner and/or other entities as restricted or non-restricted data feature(s)). Similarly, it should be noted that at least one data feature of another entity that is to be used for training the MLM may be non-restricted (at least with respect to the requesting entity). However, in any case, since the MLM is to be trained using at least one restricted data feature, the training will nevertheless take place via sandbox 229 that is inaccessible to the requesting entity. As such, restricted and non-restricted features of the requesting entity and of other data owners may all be populated into data set 284.

Accordingly, the network-based processing system 210 may commence training of the MLM via sandbox 229 in accordance with the data features in data set 284, at least one of which comprises a restricted data set of another data owner. In various examples, the training may include validation and/or testing, It should be noted that as referred to herein, a machine learning model (MLM) (or machine learning-based model), may broadly include models for prediction, classification, forecasting, and/or detection, and may comprise a machine learning algorithm (MLA) that has been “trained” or configured in accordance with input data (e.g., training data) to perform a particular service, e.g., to detect a likely failure or overload of a network element, to forecast weather, to classify images, to predict user arrival times, and so forth. Examples of the present disclosure may incorporate various types of MLAs/models that utilize training data, such as support vector machines (SVMs), e.g., linear or non-linear binary classifiers, multi-class classifiers, deep learning algorithms/models, such as deep learning neural networks or deep neural networks (DNNs), generative adversarial networks (GANs), decision tree algorithms/models, k-nearest neighbor (KNN) clustering algorithms/models, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. In one example, MLAs/MLMs of the present disclosure may be in accordance with an open source library, such as OpenCV, which may be further enhanced with domain specific training data.

In one example, an MLM trained via sandbox 229 may be returned to the requesting entity, e.g., at data owner device 231 and/or sandbox 226. Notably, although the MLM may have been trained using one or more restricted data features, the trained MLM may be accessed, used, and deployed by the requesting entity, e.g., for whichever purpose(s) the MLM was intended to serve. It should be noted that although the MLM may have been trained with one or more restricted data features as predictors/independent variables, the requesting entity may obtain permission or may have the authorization to access and use additional input data that may be related to such restricted data features. For instance, a restricted data feature may comprise a user's mobile computing device location information over a six month period. However, the requesting entity may obtain permission to access the mobile computing one-off device location data at a given instance, e.g., in a connection with a specific online or in-person retail transaction, in connection with a specific request for service from a transportation service provider (e.g., a taxicab service, a package delivery service, etc.), in connection with a home automation service (such as adjusting temperatures, light settings, etc. of one or more premises zones in anticipation of a user arrival, etc.), and so forth. For example, the user may specifically provide consent via a pop-up request presented by an application of a user's mobile computing device or the like. However, in another example, the MLM may be deployed at the data sharing platform 205 (e.g., via network-based processing system 210 or via one or more other components (not shown)). In this case, to the extent any one or more of the run-time inputs/predictors may comprise “restricted” data, such data may be accessed by the data sharing platform 205, e.g., while remaining inaccessible to the requesting entity for which the MLM may be deployed.

In one example, the sandbox 229 may be closed and the data set 284 released after the MLM is trained and provided back to the requesting entity. For instance, the sandbox 229 may be instantiated as a virtual machine, container, or the like, and may be de-instantiated upon completion of the MLM training. In one example, any storage, memory, or other resources utilized for the restricted data features may be overwritten and/or other similar preventative measures implemented to further prevent data leakage. In one example, the network-based processing system 210 may provide feedback to one or more data owners of restricted and/or non-restricted data features that may have been used for MLM training, e.g., an identification of the MLM, the purpose and/or subject matter of the MLM, an identification of the requesting entity for which the MLM was trained, etc. In one example, the feedback may comprise user feedback obtained from the requesting entity, e.g., a one to five star rating, a zero to ten rating, any comments about the data feature and/or a performance of the MLM, etc. In one example, one or more aspects of such feedback may alternatively or additionally be added to one or more entries associated with one or more data features in the feature catalog 245, which may be discovered by other requesting entities when seeking to train additional MLMs in the future.

It should be noted that although the foregoing describes an example in which a data owner is also the requesting entity obtaining MLM training via data sharing platform 205, in another example, a requesting entity may not be a “data owner,” but could be another entity that seeks MLM training using at least one restricted data feature that is made available and may be found in feature catalog 245. It should also be noted that in one example, an entity seeking MLM training is not prevented from requesting full access to a restricted data feature from a data owner. For example, the data owner may grant such permission, may deny the request at the data owner's discretion, may request further information on the intended use, etc. in accordance with any legal, regulatory, contractual or other obligations, or the like. In addition, although the present disclosure provides for enhanced protection of data features by preventing access of non-authorized entities to restricted data features, in some examples, various data cleansing, anonym izing, or similar transformations or protections may be applied to various data features, such as omission of house numbers for street addresses or generalization to city/state and/or zip code only, storing of hash values for names, homomorphic encryption for certain values, replacing specific values with randomly selected values within a band/range of values, etc. It should also be noted that in one example, a data set owner may also be a provider of the data sharing platform 205. For instance, a telecommunication network may be a host/provider of the data sharing platform 205 and may maintain restricted data features for limited use by other entities in data set 281. Thus, these and other modification are all contemplated within the scope of the present disclosure.

FIG. 3 illustrates a flowchart of an example method 300 for training a machine learning model on behalf of a first entity in accordance with at least one restricted data feature of at least a second entity that is inaccessible to the first entity to generate a trained machine learning model, in accordance with the present disclosure. In one example, steps, functions, and/or operations of the method 300 may be performed by a device or apparatus as illustrated in FIG. 1, e.g., one or more of servers 135, or by a network-based processing system 205 as illustrated in FIG. 2. Alternatively, or in addition, the steps, functions and/or operations of the method 300 may be performed by a processing system collectively comprising a plurality of devices as illustrated in FIG. 1 such as one or more of servers 135, DB(s) 136, endpoint devices 111-113 and/or 121-123, or as illustrated in FIG. 2, such as network-based processing system 210, data sharing platform 205, data owner devices 231-233, and so forth. In one example, the steps, functions, or operations of method 300 may be performed by a computing device or system 400, and/or a processing system 402 as described in connection with FIG. 4 below. For instance, the computing device 400 may represent at least a portion of a platform, a server, a system, and so forth, in accordance with the present disclosure. For illustrative purposes, the method 300 is described in greater detail below in connection with an example performed by a processing system. The method 300 begins in step 305 and proceeds to step 310.

At step 310, the processing system obtains a request from a first entity to train a machine learning model. In one example, step 310 may include obtaining the machine learning model from the first entity. In one example, step 310 may alternatively or additionally include obtaining hyperparameters of the machine learning model. In one example, the machine learning model may be stored via a data storage platform of the processing system (e.g., in a sandbox of the first entity that is provided via the processing system and the data storage platform, such as illustrated and described in connection with the example(s) of FIG. 2). In one example, the request may include an identification of at least one data feature of at least a second entity for training the machine learning model. For instance, in one example, the at least one data feature of the at least the second entity may be presented in a data feature catalog of features of a plurality of different entities that are available for training of machine learning models via the processing system. The catalog may include information about each data feature, such as whether the data feature is “restricted” or “not restricted,” a feature name/descriptor, a date/time range of the data feature, a data format of the contents of the data feature, a data owner identification, one or more user ratings of the data feature, a feature profile/fingerprint (e.g., statistics of the data features, such as high value, low value, mean, median, entropy metric, uniqueness metric, etc.), a text description of the data feature (e.g., provided by the data feature owner), an ontology of the data feature, a lineage of the data feature, and so forth.

Thus, for example, the first entity may have selected the at least one data feature of the at least the second entity from the catalog. In one example, the request may also include an identification of at least one data feature of the first entity for training the machine learning model. In one example, the request may also include date/time ranges to select from the data feature(s), or other ranges of other value(s). In one example, the data features may be stored in multiple data stores (e.g., one per data feature owner or the like), or a single data store with segregated storage and access (e.g., separate sandboxes on a single platform). In one example, the data features may comprise “engineered” data features, e.g., features that may be generated from one or more raw data sources or other features, e.g., aggregate and/or summary features, features that have been “cleansed,” “sanitized,” “anonymized,” etc., and so forth.

At optional step 320, the processing system may obtain at least one data feature of the first entity. For instance, in one example, optional step 320 may comprise accessing the at least one data feature of the first entity via a data storage platform of the processing system (e.g., the first entity may have data features stored in a feature store provided by or otherwise associated with the processing system). In another example, the first entity may provide the at least one data feature of the first entity in connection with the request of step 310.

At step 330, the processing system accesses at least one data feature of at least a second entity. In accordance with the present disclosure, the at least one data feature of the at least the second entity may comprise a restricted data feature that is inaccessible to the first entity. In one example, step 330 may comprise accessing the at least one data feature of the at least the second entity via a data storage platform of the processing system (e.g., a feature store). For instance, in one example, for each entity of a plurality of different entities including the at least the second entity, the data storage platform may store respective features. In addition, for the at least the second entity, features of the at least the second entity are accessible to the at least the second entity via the data storage platform, and are inaccessible to others of the plurality of entities via the data storage platform. However, the features of the at least the second entity are further accessible to the processing system via the data storage platform, e.g., in accordance with at least one consent obtained from the at least the second entity. In addition, it should be noted that in one example, the accessing may further be in accordance with a user consent to the second entity for the use of the user's data contained in the data feature(s) of second entity (e.g., including limited sharing as a restricted data feature (or features) as described herein). In another example, step 330 may comprise accessing the at least one data feature of the at least the second entity from a separate feature store (or feature stores) associated with the at least the second entity, e.g., over one or more networks. In particular, it should again be noted that a restricted data feature may already be stored in data storage platform associated with the processing system, or may be obtained by the processing system from another data storage platform associated with the data feature owner (e.g., in encrypted/protected format and not to be further exported to any requesting entity or others).

At step 340, the processing system trains the machine learning model on behalf of the first entity in accordance with the at least one data feature of the at least the second entity to generate a trained machine learning model. As noted above, the at least one data feature of the at least the second entity may comprise a restricted data feature that is inaccessible to the first entity. In one example, the training of the MLM at step 340 may further comprise training the machine learning model in accordance with the at least one data feature of the first entity that may be obtained at optional step 320 and the at least one data feature of the at least the second entity that may be obtained at step 330.

To illustrate, in one example, the first entity may comprise a provider of a first internet-of-things ecosystem and the at least the second entity may comprise a provider of a second internet-of-things ecosystem. In such case, the at least one data feature of the at least the second entity and the at least one data feature of the first entity may each comprise data from a respective internet-of-things device at a user premises. Continuing with the present example, the machine learning model may be trained to predict a sleep time or a wake time for at least one IoT device, to predict a preferred setting for at least one IoT device (e.g., to set a thermostat temperature, to turn heating or cooling on or off, to turn on or off lights, to set light level, or the like), and so forth.

In another example, the first entity may comprise a transportation service provider and the at least the second entity may comprise a telecommunication network service provider, where the at least one data feature of the at least the second entity may comprise endpoint device location data and where the at least one data feature of the first entity may comprise vehicle location data of one or more vehicles of the transportation service provider. In such case, the machine learning model may be trained to predict a location and time for a transportation pick up or drop off, or the like. In still another example, the first entity may comprise a first educational entity and the at least the second entity may comprise a second educational entity, where the at least one data feature of the at least the second entity and the at least one data feature of the first entity may each comprise data associated with respective students of the first educational entity or the second educational entity. In such case, the machine learning model may be trained to predict student performance or progress (e.g., standardized test performance, graduation rates, speed of process through textbook or other aspects of curriculum, enrollment ratios in courses or other programs, level interest in subject matter, etc.).

In one example, step 340 may proceed in accordance with a machine learning algorithm (MLA) and hyperparameters selected by the first entity (e.g., which may be provided as part of or in connection with the request at step 310). In another example, step 340 may include automated machine learning (auto ML). For instance, the processing system may use portions of data features or may use different data features as training data and testing data respectively, and may train multiple machine learning models of different types and/or with different hyperparameters, and may select a machine learning model for deployment/use (or may select multiple machine learning models to deploy as an ensemble). In still another example, step 340 may comprise semi-automated machine learning, e.g., where the first entity may specify a set of MLAs/MLMs for consideration, but where the processing system may then choose from among the candidate models via training/testing, may tune the hyperparameters thereof, etc.

At step 350, the processing system provides the trained machine learning model to the first entity. For instance, in one example, step 350 may comprise transmitting the trained machine learning model to the first entity. Accordingly, the first entity may deploy the trained machine learning model in accordance with its intended use. For instance, the first entity may obtain new data pertaining to the at least one data feature of the second entity for run-time prediction and apply to the trained MLM. In other words, the first entity may not have access to the at least one data feature of the second entity (e.g., historical data) but may obtain one-time, on demand data (e.g., a location of a single new purchase, instead of an entire 6 month history of purchase locations, or the like). In an example in which the machine learning model is trained for prediction/forecasting related to IoT/premises automation platforms, the trained MLM may be deployed to one or more IoT devices of either platform at a premises of the first entity. For example, the MLM may be trained to predict a user's lighting preferences for times of the day, days of the week, etc., may be trained to predict the user's arrival time home after work, and so forth. In one example, there may be lights, lighting controllers, or other IoT devices at the premises from two different platforms that may be similarly controlled according to the MLM predictions. In other words, the MLM may be deployed to one or both (or more than two) platforms. Notably, the first entity may prefer that data features not be shared across the two platforms, but it may still be desirable to have the benefit of learning from the data of both platforms. It should be noted that in another example, step 350 may comprise deploying the trained machine learning model via the processing system. In such case, in one example, the method 300 may proceed to include optional steps 360-380.

At optional step 360, the processing system may obtain an input data set comprising new data associated with the at least one data feature of the second entity. For instance, the processing system may obtain new data pertaining to the at least one data feature of the second entity for run-time prediction. In one example, optional step 360 may further include obtaining new data pertaining to the at least one data feature of the first entity described in connection with optional step 320. In one example, optional step 360 (and subsequent optional steps 370 and 380) may be initiated on demand, e.g., by the first entity. Alternatively, or in addition, the processing system may apply input data sets to the MLM periodically or on another schedule, as input data sets become available, etc.

At optional step 370, the processing system may apply the input data set to the trained machine learning model to obtain at least one output of the trained machine learning model. For instance, the input data set may comprise predictors/independent variable, wherein the output may comprise the dependent variable. The output may comprise a class (e.g., from among two or more possible classes (e.g., where the MLM comprises a binary classifier, a multi-class classifier, etc.), a class with a confidence score, one or more value (e.g., a predicted temperature, wind speed, location, time, etc.), a likelihood score, or the like.

At optional step 380, the processing system may provide the at least one output to the first entity. For instance, the result/output of the machine learning model may be transmitted to the first entity.

At optional step 390, the processing system may provide usage feedback information to the at least the second entity associated with a usage of the at least one data feature of the at least the second entity for training the machine learning model. For instance, the usage feedback information may include one or more of: an identity of the first entity, a type of the machine learning model, a topic of the machine learning model, at least one additional feature used to train the machine learning model, a performance of the at least one machine learning model (e.g., an accuracy, a time to generate predictions, a training time to reach a desired accuracy level, etc.), and so forth.

Following step 390, the method 300 proceeds to step 395 where the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 310-350 or steps 310-390 for the same or a different first entity and for one or more other machine learning models to be trained. In one example, the method 300 may include presenting a catalog of data features (e.g., prior to step 310). In one example, the method 300 may include obtaining feedback from the first entity regarding the at least one data feature of the at least the second entity (e.g., to provide at optional step 390). In one example, the method 300 may include updating the catalog in accordance with the feedback (e.g., in addition to providing feedback to the at least the second entity at optional step 390). In one example, the method 300 may further include deleting and/or overwriting the at least one data feature of the at least the second entity, e.g., from the data storage platform associated with the processing system and/or from a sandbox thereof instantiated for the sole purpose of training the machine learning model on behalf of the first entity. In one example, the method 300 may be expanded or modified to include steps, functions, and/or operations, or other features described above in connection with the example(s) of FIGS. 1 and 2, or as described elsewhere herein. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components, devices, and/or systems illustrated in FIG. 1 or FIG. 2, or described in connection with FIG. 3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for training a machine learning model on behalf of a first entity in accordance with at least one restricted data feature of at least a second entity that is inaccessible to the first entity to generate a trained machine learning model, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for training a machine learning model on behalf of a first entity in accordance with at least one restricted data feature of at least a second entity that is inaccessible to the first entity to generate a trained machine learning model (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for training a machine learning model on behalf of a first entity in accordance with at least one restricted data feature of at least a second entity that is inaccessible to the first entity to generate a trained machine learning model (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor, a request from a first entity to train a machine learning model;
accessing, by the processing system, at least one data feature of at least a second entity;
training, by the processing system, the machine learning model on behalf of the first entity in accordance with the at least one data feature of the at least the second entity to generate a trained machine learning model, wherein the at least one data feature of the at least the second entity is a restricted data feature that is inaccessible to the first entity; and
providing, by the processing system, the trained machine learning model to the first entity.

2. The method of claim 1, further comprising:
obtaining, by the processing system, at least one data feature of the first entity.

3. The method of claim 2, wherein the obtaining of the at least one data feature of the first entity comprises accessing the at least one data feature of the first entity via a data storage platform of the processing system.

4. The method of claim 2, wherein the training further comprises training the machine learning model in accordance with the at least one data feature of the first entity and the at least one data feature of the at least the second entity.

5. The method of claim 4, wherein the first entity comprises a provider of a first internet-of-things ecosystem and wherein the at least the second entity comprise a provider of a second internet-of-things ecosystem, wherein the at least one data feature of the at least the second entity and the at least one data feature of the first entity each comprises data from a respective internet-of-things device at a user premises.

6. The method of claim 1, wherein the accessing of the at least one data feature of the at least the second entity comprises accessing the at least one data feature of the at least the second entity via a data storage platform of the processing system.

7. The method of claim 6, wherein for each entity of a plurality of different entities including the at least the second entity, the data storage platform stores respective features, wherein for the at least the second entity, features of the at least the second entity are accessible to the at least the second entity via the data storage platform, and are inaccessible to others of the plurality of entities via the data storage platform.

8. The method of claim 7, wherein the features of the at least the second entity are further accessible to the processing system via the data storage platform.

9. The method of claim 8, wherein the at least one data feature of the at least the second entity is accessible to the processing system in accordance with at least one consent obtained from the at least the second entity.

10. The method of claim 1, wherein the providing the trained machine learning model to the first entity comprises transmitting the trained machine learning model to the first entity.

11. The method of claim 1, wherein the providing the trained machine learning model to the first entity comprises deploying the trained machine learning model via the processing system.

12. The method of claim 11, further comprising:
obtaining an input data set comprising new data associated with the at least one data feature of the second entity;
applying the input data set to the trained machine learning model to obtain at least one output of the trained machine learning model; and
providing the at least one output to the first entity.

13. The method of claim 1, further comprising:
providing usage feedback information to the at least the second entity associated with a usage of the at least one data feature of the at least the second entity for training the machine learning model.

14. The method of claim 13, wherein the usage feedback information comprises at least one of:
an identity of the first entity;
a type of the machine learning model;
a topic of the machine learning model; or
at least one additional feature used to train the machine learning model.

15. The method of claim 1, wherein the obtaining further comprises obtaining the machine learning model from the first entity.

16. The method of claim 1, wherein the machine learning model is stored via a data storage platform of the processing system.

17. The method of claim 1, wherein the request further includes an identification of the at least one data feature of the at least the second entity for training the machine learning model.

18. The method of claim 17, wherein the at least one data feature of the at least the second entity is presented in a data feature catalog of features of a plurality of different entities that are available for training of machine learning models.

19. A non-transitory computer-readable medium storing instructions which, when executed by a processing system including at least one processor, cause the processing system to perform operations, the operations comprising:
obtaining a request from a first entity to train a machine learning model;
accessing at least one data feature of at least a second entity;
training the machine learning model on behalf of the first entity in accordance with the at least one data feature of the at least the second entity to generate a trained machine learning model, wherein the at least one data feature of the at least the second entity is a restricted data feature that is inaccessible to the first entity; and
providing the trained machine learning model to the first entity.

20. An apparatus, comprising:
a processing system including at least one processor; and
a non-transitory computer-readable medium storing instructions which, when executed by the processing system, cause the processing system to perform operations, the operations comprising:
obtaining a request from a first entity to train a machine learning model;
accessing at least one data feature of at least a second entity;
training the machine learning model on behalf of the first entity in accordance with the at least one data feature of the at least the second entity to generate a trained machine learning model, wherein the at least one data feature of the at least the second entity is a restricted data feature that is inaccessible to the first entity; and
providing the trained machine learning model to the first entity.
